(19) United States
(12) Patent Application Publication
(10) Pub. No.: US 2004/0119180 A1
(43) Pub. Date: Jun. 24, 2004

(54) Method of producing a dental prosthesis

(76) Inventors: Sybille Frank, Seefeld (DE); Holger Hauptmann, Sindelsdorf (DE); Stefan Moscheler, Herrsching (DE); Robert Schnagl, Landsberg (DE); Daniel Suttor, Seefeld (DE)

Correspondence Address: MUETING, RAASCH & GEBHARDT, P.A., P.O. BOX 581415, MINNEAPOLIS, MN, 55458, US

(21) Appl. No.: 10/468,071

(22) PCT Filed: Feb. 14, 2002
(86) PCT No.: PCT/EP02/01594

(30) Foreign Application Priority Data
Feb. 14, 2001 (DE) 101 07 451.4

(51) Int. Cl. A61C 13/00; C04B 35/03

(52) U.S. Cl. 264/16; 264/162; 501/126; 501/127

(57) ABSTRACT

The invention relates to a method of producing a dental prosthesis, comprising the steps:

a) preparation of a blank,

b) machining of the blank by milling processes,

c) dense-sintering of the blank in a temperature range of from 1200 to 1650° C.,

the blank comprising a pre-sintered material and having a green strength of from 31 to 50 MPa.

The invention relates to a method of producing a dental prosthesis. The invention relates also to pre-sintered blanks of zirconium oxide ceramics which have a green strength within a selected range.

A ceramic dental prosthesis is usually produced by grinding dense-sintered ceramic blanks.

For example, EP-B-0 160 797 describes a blank and its use in the production of dental mouldings by means of a grinding tool. Furthermore, EP-A-0 630 622 discloses a method of producing ceramic dental prostheses in which a blank of a certain composition is subjected to grinding using a rotating tool.

A particular disadvantage that arises in the machining of dense-sintered blanks is that the latter are extremely hard, which results in long machining times and a high degree of wear to the tool. The costs of machining such blanks is therefore very high.

A further disadvantage of grinding processes for machining or producing a ceramic dental prosthesis is that the absence of defined cutting edges means that it is not possible to obtain ground blanks having a highly accurate shape.

The machining of blanks that have been pre-sintered to a certain degree of hardness is mentioned in principle on page 3, column 3, line 13 ff, of EP-A-0 630 622, but the blanks are still machined by grinding processes.

Pre-sintered blanks are less hard than dense-sintered blanks and are harder than unsintered blanks. It is therefore desirable in principle to use pre-sintered blanks in order to ensure ease of machining or to render machining possible at all.

For example, the machining tools are thus subjected to less wear, which results in the tools having a longer service life and thus in considerably reduced costs. The production of extremely fine microstructures is also possible for the first time, because the predictable shrinkage of the ceramics during dense-sintering results in a further reduction in the size of the microstructures produced. With pre-sintered blanks, the microscopic damage to the ceramics which frequently occurs during machining can be remedied in the context of the dense-sintering process.

The production of a dental prosthesis by machining in the non-dense-sintered state requires completely homogeneous distribution of strength and hardness and of density in every spatial direction of the ceramic blank, which distribution is retained especially after the pre-sintering of the blank. It is advantageous to avoid variations in the density and hardness distribution of the ceramics when filigree structures or multi-unit bridges are to be produced, because even the smallest inhomogeneities can give rise to predetermined breakage points which can considerably impair the durability of such complex structures during machining or can result in variable sintering behaviour which is revealed as distortion of the workpiece on sintering. Such distortion results in poor accuracy of fit, however, and thus renders the dental prosthesis unusable.

The machining of pre-sintered blanks has not been put into practice on a technical scale hitherto for the following reasons:

The dense-sintering of a pre-sintered blank after machining is associated with changes in its dimensions which are difficult to calculate and which can be brought to the true milling parameters only by means of complicated procedures. Dental prosthetics not having accuracy of fit therefore subsequently have to undergo correction after dense-sintering. Such corrections have to be carried out using erosion methods on account of the relatively high degree of hardness of the dense-sintered dental prosthetics and are to be regarded as very critical, because self-healing of the damage to surface structures, which occurs during the dense-sintering process, cannot be repeated.

In summary there is a considerable need for methods of producing a dental prosthesis having accuracy of fit by the use of pre-sintered ceramic blanks.

The aim of the invention is therefore to provide an improved method of producing a high-precision dental prosthesis having accuracy of fit.

Surprisingly, this aim can be achieved by a method of producing a dental prosthesis that comprises the following steps:

a) preparation of a blank,

b) machining of the blank by milling processes,

c) dense-sintering of the blank in a temperature range of from 1200 to 1650° C.,

the blank comprising a pre-sintered material and having a green strength of from 31 to 50 MPa, preferably from 31 to 40 MPa.

Blanks in the context of this invention are non-machined blocks of material or green compacts which then undergo shaping by means of machining. Such blanks may consist of an extremely wide range of materials, especially ceramics.

A dental prosthesis in the context of this invention is to be understood as being especially a crown or a three-unit or multi-unit bridge. The blanks according to the invention are especially suitable for the production of three-unit and multi-unit bridges.

Machining in the context of this invention is to be understood as meaning milling operations for shaping a blank which have the result that the blank is converted into a form as close as possible to the natural tooth. Machining is not to be understood as being the cleaning of a blank machined in the above sense or the removal of supporting or holding structures resulting from the embedding of the blank in a blank holder, even when such cleaning can be carried out by milling processes.

The terms “comprise” and “containing” in the sense of the present invention introduce a non-exhaustive list of features. Customary green strengths known from the prior art for ceramic dental blanks lie in the relatively high strength range, for example from 75 to 110 MPa; such blanks are not suitable for use for the invention.

It has been found that the machining of pre-sintered blanks having green strengths outside the range according to the invention does not yield useful results. Lower green strengths result in soft blanks which may break during milling, while higher green strengths result in hard blanks which cannot be machined using customary machining processes.

The machining of blanks pre-sintered according to the invention is carried out by means of milling processes. The extremely sharp cutting edges of the milling tools make it possible to create extremely fine microstructures. The cutting edges of the tool remain sharp over a long period of use, because in the pre-sintered state the blank has only a low degree of hardness and strength. During the milling of the blank, the tool of the machine operates, for example, at a speed of from 5,000 to 40,000 rev/min, preferably from 15,000 to 25,000 rev/min, at a rate of advance of from 20 to 5,000 mm/min, preferably from 500 to 3,500 mm/min, for coarse machining. Fine machining is carried out, for example, at a speed of from 5,000 to 50,000 rev/min, preferably from 18,000 to 35,000 rev/min, at a rate of advance of from 20 to 5,000 mm/min, preferably from 500 to 3,500 mm/min. For both machining steps, a milling tool having a diameter of, for example, from 0.8 to 4 mm is used.

Especially preferably, the blanks are machined without a supporting structure, as described, for example, in the Example of EP-A2-0 824 897. The machining operation is carried out from the side of the finished machined dental prosthetic that is in contact with the tooth stump and from the side that is not in contact with the tooth stump, it being especially advantageous that during the dense-sintering operation the blank need not be surrounded or supported by a high-temperature embedding composition.

In the course of the dense-sintering process, the converted blank can be held by means of support devices that adapt themselves automatically to the shrinkage in dimensions occurring during the firing process, such as are known, for example, from patent application DE-199 04 523, in order to avoid distortion during the sintering process.

The blanks can consist of customary dental ceramics. Dental ceramics are to be understood in the context of this invention as meaning compositions which, in addition to comprising the customary ceramic constituents, may also contain small amounts of other constituents (additives), such as sintering aids. The formulation data in the form of components and % by weight always relate to a product that does not contain any further additives. It will be understood that small traces of additives, including in the pre-sintered or finally sintered ceramics, are possible for kinetic, thermodynamic or chemical reasons and are therefore also to be understood as being included within the scope of this invention.

In particular, the presence of impurities promotes the formation of glass phases or glassy portions. Preference is therefore given also to blanks which do not form glass phases or glassy portions during dense-sintering.

The blanks according to the invention preferably also exhibit, on shrinkage, a deviation from linearity of less than 0.05%, especially less than 0.01%, per spatial direction.

The blanks according to the invention preferably consist of aluminium oxide or zirconium oxide ceramics, special preference being given to zirconium oxide ceramics.

It is known than the strength of non-metallic inorganic systems is generally dependent upon the critical stress intensity factor K_{ic}. That factor is considerably lower in the case of amorphous materials, for example glasses, than in the case of purely crystalline systems (D. Munz/T. Fett: Mechanisches Verhalten keramischer Werkstoffe, Springer-Verlag). Accordingly, the strength of ceramics is also reduced when amorphous phases are formed at the particle boundaries. The ceramics especially suitable for use in accordance with the invention therefore have, for example, a value for K_{ic} of from 5 to 10, preferably from 8 to 10, determined according to EN 843.

Surprisingly it has been found that zirconium-oxide-based ceramics having a sintering additive of from 0.1 to 0.50% by weight of at least one of the oxides of the elements aluminium, gallium, germanium and indium exhibit particularly advantageous and uniformly distributed hardness and strength. They are therefore especially suitable for the production according to the invention of a complex dental prosthesis and filigree structures. It is of advantage when the oxides of the above-mentioned elements are added in an amount as defined above and are homogeneously distributed and are not (as would be, for example, impurities) non-uniformly distributed in varying concentrations. Such a homogeneous distribution can be achieved, for example, by coprecipitation, as described in the Example of this invention.

In addition, uniform distribution of the particles formed during the pre-sintering process is advantageous. The particle form of the particles is preferably equiaxial with an average particle diameter of less than 1 μm, especially less than 0.7 μm.

The blanks suitable for use for the invention usually have a pore volume of from 50 to 65%. The average pore size is customarily in the range of from 3 μm to 0.1 μm, the range from 2 μm to 0.2 μm being preferred.

In the case of such ceramics, the pre-sintering process is carried out in a preferred temperature range of from 850° C. to 1000° C., especially between 950° C. and 995° C., in order to achieve the green strength according to the invention. The pre-sintering process is carried out, for example, over a period of from 30 h to 55 h.

Such ceramic systems have, as is known, the tendency to shrink anisotropically, that is to say they exhibit different shrinkage in the three spatial directions. Since this shrinkage in each spatial direction is in itself linear, such ceramics are surprisingly extremely suitable for the production of a dental prosthesis of extreme accuracy of fit and complexity.

The use of zirconium oxide ceramics in the field of medicine is generally known. Pure zirconium oxide cannot, however, be used for mechanical applications because during the cooling process after the sintering its volume changes too much as a result of changes in modification. This process can be inhibited, however, by the addition of magnesium oxide, cerium oxide or yttrium oxide. A comprehensive discussion can be found in “Aluminium- und Zirkonoxidkeramik in der Medizin”, special publication of Industrie Diamanten Rundschau, IDR 2/1993 and in EP-A-0 634 149.

The addition to such ceramics of from 0.1 to 0.50% by weight, preferably from 0.15 to 0.50% by weight, especially from 0.20 to 0.50% by weight, very especially from 0.25 to 0.50% by weight, of at least one of the oxides of the elements aluminium, gallium, germanium and indium results in a lowering of the sintering temperature and an increase in stability and hydrolytic resistance in the in-use state. Such data can be found for the oxide of aluminium in the product information of the Tosoh company “Zirconia Powder” 09/97. The ceramic is not suitable, however, for the production of a dental prosthesis having accuracy of fit in accordance with the present invention, because unless the green strength according to the invention is adhered to, milling to form a high-precision dental prosthesis is not possible on account of the effects discussed above.

The present invention relates also to a pre-sintered blank of zirconium oxide ceramic of composition (1), containing:

(A) from 91 to 98.45% by weight, preferably from 91 to 97.25% by weight, of zirconium oxide,

(B) from 0 to 3.5% by weight, preferably from 0 to 2.5% by weight, of hafnium oxide,

(C) from 1.5 to 6.0% by weight, preferably from 2.5 to 6.0% by weight, of yttrium oxide,

(D) from 0.05 to 0.50% by weight, preferably from 0.15 to 0.50% by weight, especially from 0.20 to 0.50% by weight, very especially from 0.25 to 0.50% by weight, of at least one of the oxides of the elements aluminium, gallium, germanium and indium,

(E) from 0 to 1.9% by weight, preferably from 0.0005 to 1.5% by weight, of colouring additives,

it being necessary for the % by weight to add up to 100% and the blank having a green strength of from 31 to 50 MPa, preferably from 31 to 40 MPa.

Component (E) of the composition (1) is to be understood as including colouring oxides of elements of the group Pr, Er, Fe, Co, Ni, Ti, V, Cr, Cu, Mn, it being preferable to use Fe₂O₃, Er₂O₃ or MnO₂.

The invention relates also to a method of producing a ceramic dental prosthesis, wherein a blank of composition (1) is converted into a shrinkage-adapted, oversized model of the final dental prosthesis by suitable machining operations and is then dense-sintered to its final dimensions. A shrinkage-adapted model is to be understood as being a model of the desired dental prosthesis that is enlarged in accordance with a portion of the theoretically expected shrinkage.

The technical production of composition (1) is carried out by dissolution of components (A) and (B) of composition (1) contained in commercial zirconium sand with HCI, mechanical separation of the impurities having poor solubility and combination with the additives (C) and (D), which after treatment with HCI are likewise present as oxychlorides or chlorides, in the form of an aqueous, strongly acidic solution.

Additives according to component (E) having a colouring action are then added likewise in the form of chlorides, obtained by dissolution in HCI.

There then follow co-precipitation of the dissolved components by hydrolysis, calcination of the precipitation product, grinding of the calcined product to the desired final degree of fineness and, using temporary lubricants and binders, a spray-drying process.

The granules obtained in this manner can be brought into the desired preliminary form using known compaction methods. The resulting green compacts are freed of binder by means of a binder-dependent thermal treatment and pre-sintered at a temperature of between 850° C. and 1000° C., preferably between 950° C. and 995° C., for example with a dwell time of from 0.5 to 4 hours.

Ceramic powders containing components (A) to (D) are also commercially available (Tosoh, Tokyo, Japan).

The blanks machined using conventional processes, for example CAD/CAM or copy-milling, are dense-sintered at from 1200° C. to 1650° C., especially from 1350° C. to 1550° C., with a dwell time of, for example, from 1 to 3 hours.

Preferably prior to dense-sintering it is possible to carry out aesthetic operations, such as individual colouring. Suitable methods include, for example, methods in accordance with patent application DE-199 04 522, preference being given to the use of ionic solutions of at least one of the salts of rare earth elements, lanthanides or elements from the group Fe, Co, Ni, Ti, V, Cr, Cu, Mn.

After dense-sintering, if desired a ceramic blank that has been converted into a dental prosthesis is removed from a blank holder, it being possible, for example, for a holder from Utility Model DE-298 154 86 to be used during machining. Removal from a blank holder can be followed, if desired, by further machining of the blank for the purpose of removing positioning pins or connection points between the blank holder and the machined blank.

Furthermore, the blank can be veneered by customary operations. For that purpose, a veneer composition having the same coefficient of thermal expansion as the blank can be fired onto the blank. Blanks that are suitable for the present invention can have, for example, a coefficient of thermal expansion of between 9.0 and 10.5 ppm/K, preferably between 9.4 and 9.8 ppm/K.

The invention will be described in greater detail by way of Examples, but the invention shall not be limited thereby.

Data relating to strengths, especially fracture strengths, in the context of these state- ments relate to the “Punch on three ball Test” in accordance with ISO 6872.

The production of the blanks according to the invention begins with the use of preforms obtained by the application of pressure. Such preforms are produced starting, for example, from pure chlorides, oxychlorides or nitrates; in the Examples chlorides are used.

### PRODUCTION EXAMPLES 1 and 2

### Zirconium Oxide Ceramics Having an Aluminium Oxide Content

In order to obtain about 200 g of finished doped compressed granules, the components according to the following Table are dissolved in distilled water:

| | M(ZrCl₄) | M(YCl₃.6 H₂O) | M(AlCl₃) | M(FeCl₃) | M(ErCl₃) |
|---|---|---|---|---|---|
| No. | [g] | [g] | [g] | [g] | [g] |
| 1 [coloured] | 355.6 | 33.4 | 0.65 | 0.77 | 0.29 |
| (% content as oxide) | (94.0) | (5.17) | (0.25) | (0.2) | (0.38) |
| 2 [uncoloured] | 357.66 | 33.36 | 0.65 | 0 | 0 |
| (% content as oxide) | (94.55) | (5.20) | (0.25) | | |
| Component | (A) | (C) | (D) | (E) | (E) |

There follows co-precipitation of the dissolved components by hydrolysis, 32 litres of 6M aqueous NH₄0H solution being added to the above-mentioned solution. An at least 30 fold excess of the OH concentration relative to the stoichiometric requirement is advisable. The precipitation product must then be washed free of Cl. The calcination of the precipitation product is carried out at 700° C. over a period of 0.75 hour, followed by grinding of the calcined product to a final degree of fineness of D_{50 =}0.6 μm and by a spray-drying process using temporary lubricants and binders (here: 2.0% by weight PVA, 0.15% by weight oleic acid, based on the oxide batch).

The resulting granules are formed into preforms of dimensions d=31 mm and 1=150 mm using an isostatic press, for example at from 1500 to 2500 bar, preferably from 1700 to 2200 bar.

The preforms are freed of binder by a thermal treatment (heating rate: 4 K/min to 650° C., 1 hour dwell time) and pre-sintered at a temperature of 970° C. with a dwell time of 0.5 hour to form the blanks suitable for use in accordance with the invention.

### Method Examples

For the production of bridges having accuracy of fit, blanks produced in accordance with Production Examples 1 and/or 2 are milled using a CAD/CAM system and dense-sintered with the following parameters:

Heating rate: 10 K/min to final temperature: 1500° C. Dwell time at final temperature: 2 hours

The result in both cases is a dental prosthesis of high strength (σ>1000 MPa) and extremely high accuracy of fit.

1. Method of producing a dental prosthesis, comprising the steps:
a) providing a blank,
b) machining of the blank by milling processes,
c) dense-sintering of the blank in a temperature range of from 1200 to 1650° C.,
the blank comprising a pre-sintered material and having a green strength of from 31 to 50 MPa.

2. Method according to claim 1, wherein the blank has a green strength of from 31 to 40 MPa.

3. Method according to either one of claims 1 and 2, wherein during the milling of the blank, the tool of the machine operates at a speed of from 5,000 to 40,000 rev/min and at a rate of advance of from 20 to 5,000 mm/min for coarse machining and at a speed of from 5,000 to 50,000 rev/min and at a rate of advance of from 20 to 5,000 mm/min for fine machining, and in each case with a milling tool having a diameter of from 0.8 to 4 mm.

4. Method according to any one of the preceding claims, wherein the blank is machined from the side that is in contact with the tooth stump and from the side that is not in contact with the tooth stump.

5. Method according to any one of the preceding claims, wherein the pre-sintered blank comprises zirconium oxide or aluminium oxide ceramics.

6. Dental prosthesis, producible by a method according to any one of claims 1 to 5.

7. Pre-sintered blank of zirconium oxide ceramics, containing:
(A) from 91 to 98.45% by weight of zirconium oxide,
(B) from 0 to 3.5% by weight of hafnium oxide,
(C) from 1.5 to 6.0% by weight of yttrium oxide,
(D) from 0.05 to 0.50% by weight of at least one of the oxides of the elements aluminium, gallium, germanium and indium,
(E) from 0 to 1.9% by weight of colouring additives (calculated as oxides),
it being necessary for the % by weight to add up to 100% and the blank having a green strength of from 31 to 50 MPa.

8. Pre-sintered blank according to claim 7, containing
(A) from 91 to 98.35% by weight of zirconium oxide,
(B) from 0 to 2.5% by weight of hafnium oxide,
(C) from 1.5 to 6.0% by weight of yttrium oxide,
(D) from 0.15 to 0.50% by weight of at least one of the oxides of the elements aluminium, gallium, germanium and indium,
(E) from 0 to 1.9% by weight of colouring additives,
it being necessary for the % by weight to add up to 100%.

9. Pre-sintered blank according to claim 7, containing
(A) from 91 to 98.45% by weight of zirconium oxide,
(B) from 0 to 3.5% by weight of hafnium oxide,
(C) from 1.5 to 6.0% by weight of yttrium oxide,
(D) from 0.05 to 0.50% by weight of aluminium oxide,
(E) from 0 to 1.9% by weight of colouring additives,
it being necessary for the % by weight to add up to 100%.

10. Pre-sintered blank according to any one of claims 7 to 9, which has a green strength of from 31 to 50 MPa.

11. Pre-sintered blank according to any one of claims 7 to 10, which is obtained by sintering at a temperature of from 850° C. to 1000° C.

12. Pre-sintered blank according to any one of claims 7 to 11, which exhibits, a deviation from linearity of the shrinkage per spatial direction of less than 0.05%.

13. Use of a blank of pre-sintered material having a green strength of from 31 to 50 MPa in a method of producing a dental prosthesis, the blank being machined prior to dense-sintering.

14. Method of producing a dental prosthesis according to any one of claims 1 to 5, wherein a blank according to any one of claims 7 to 12 is converted by milling into a shrinkage-adapted, oversized model of the final dental prosthesis and is dense-sintered to its final dimensions.

15. Method of producing a dental prosthesis according to any one of claims 1 to 5, wherein a blank according to any one of claims 7 to 12 is converted by CAD/CAM methods into a shrinkage-adapted, oversized model of the final dental prosthesis and is dense-sintered to its final dimensions.

16. Method according to either one of claims 14 and 15, wherein the pre-sintered blank is, after machining, further machined for aesthetic purposes and dense- sintered to its final dimensions.
